(19) United States
(12) Patent Application Publication
(10) Pub. No.: US 2006/0201446 A1
(43) Pub. Date: Sep. 14, 2006

(54) Lightweight, floatable animal chew toy

(76) Inventor: Philip L. Edwards, Clinton Township, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/372,829

(22) Filed: Mar. 10, 2006

Related U.S. Application Data
(60) Provisional application No. 60/660,273, filed on Mar. 10, 2005.

(51) Int. Cl. A01K 29/00

(52) U.S. Cl. 119/707

(57) ABSTRACT

A lightweight, highly resilient floatable animal chew toy having a body made of elastomeric material, a density of less than 0.95 g/cm³ and a tensile strength of at least 2.0 MPa.

### RELATED APPLICATION

This application claims priority of U.S. Provisional Patent Application Ser. No. 60/660,273 filed Mar. 10, 2005, which is incorporated herein by reference.

### FIELD OF THE INVENTION

The present invention relates to a lightweight, floatable polymeric animal chew toy.

### BACKGROUND ART

Chewable pet toys are commonly used to strengthen a pet's teeth and massage its gums. Chewable pet toys are often made from polymer materials such as rubber or plastics. Oftentimes, the chewable pet toys are made from a resilient elastomer, such as synthetic rubber, which allows the pet toy to bounce. This is desirable because dogs prefer to play with toys which bounce, especially toys which bounce in an unpredictable path. These types of pet toys are well known in the art.

However, one drawback of most chewable pet toys are that they are not buoyant in water. Floatable pet toys are desirable for pets, such as dogs, which like to play and swim in the water. Additionally, many chewable pet toys are made from rubber, which does not float in water and is unattractive to pets due to its odor.

Currently, most methods of solving the floating problem involve inserting a lightweight material, such as polystyrene, into an opening in a pet toy to improve the buoyancy of the toy. However, these approaches are problematic. It is possible that the dog could chew through the toy and obtain access to the polystyrene inside the toy. Should this happen, the dog would be able to easily rip the polystyrene into several small pieces which the pet could possible choke on, while also creating a large mess.

There is a need for a elastomeric chewable pet toy which is made of a material that is strong enough so that it will not be torn apart by the dog while at the same time being of a low enough density so that it will float in the water.

### SUMMARY OF THE INVENTION

A lightweight, highly resilient floatable animal chew toy having a body made of elastomeric material, a density of less than 0.95 g/cm³ and a tensile strength of at least 2.0 MPa.

### BRIEF DESCRIPTION OF THE DRAWINGS

FIG. 1 is a perspective view of the floatable pet toy; and

FIG. 2 is a cross-sectional view of the floatable pet toy of FIG. 1.

### DETAILED DESCRIPTION OF THE PREFERRED EMBODIMENT(S)

Reference will now be made in detail to presently preferred compositions and embodiments of the present invention, which constitute the best modes of practicing the invention presently known to the inventor. The figures are not necessarily to scale. However, it is to be understood that the disclosed embodiments are merely exemplary of the invention that may be embodied in various and alternative forms. Therefore, specific details disclosed herein are not to be interpreted as limiting, but merely as representative bases for teaching one skilled in the art to variously employ the present invention.

Except where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of”, and ratio values are by weight; the term “polymer” includes “oligomer”, “copolymer”, “terpolymer”, and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

Certain non-limiting aspects of the present invention are described below:

1. A lightweight, highly resilient floatable animal chew toy comprising:

a body made of elastomeric material having a density of less than 0.95 g/cm³ and a tensile strength of at least 2.0 MPa.

2. A lightweight, highly resilient, floatable animal chew toy comprising a body molded of elastomeric material having a density in the range of 0.25 to 0.95 g/cm³ and a tensile strength in the range of 2.0 to 10.0 MPa.

3. The animal chew toy of aspect 2 wherein the material has a minimum elongation in the range of 200%-600%.

4. The animal chew toy of aspect 2 wherein the material comprises a cellular material.

5. The animal chew toy of aspect 4 wherein the cellular material contains substantially closed cells.

6. The animal chew toy of aspect 4 wherein the material comprises a microcellular material.

7. The animal chew toy of aspect 6 wherein the microcellular material comprises pores and has a pore density of 20-48 pores/cm³.

8. The animal chew toy of aspect 6 wherein the microcellular material comprises pores having an average pore diameter of 25-200 microns.

9. The animal chew toy of aspect 8 wherein the material has a pore density of 15-46 pores/cm³.

10. The animal chew toy of aspect 6 wherein the material comprises microcellular polyurethane.

11. The animal chew toy of aspect 2 wherein the material has a flavor desirable to a dog.

12. The animal chew toy of aspect 6 wherein the microcellular material comprises pores and has a pore density of 15-46 pores/cm³.

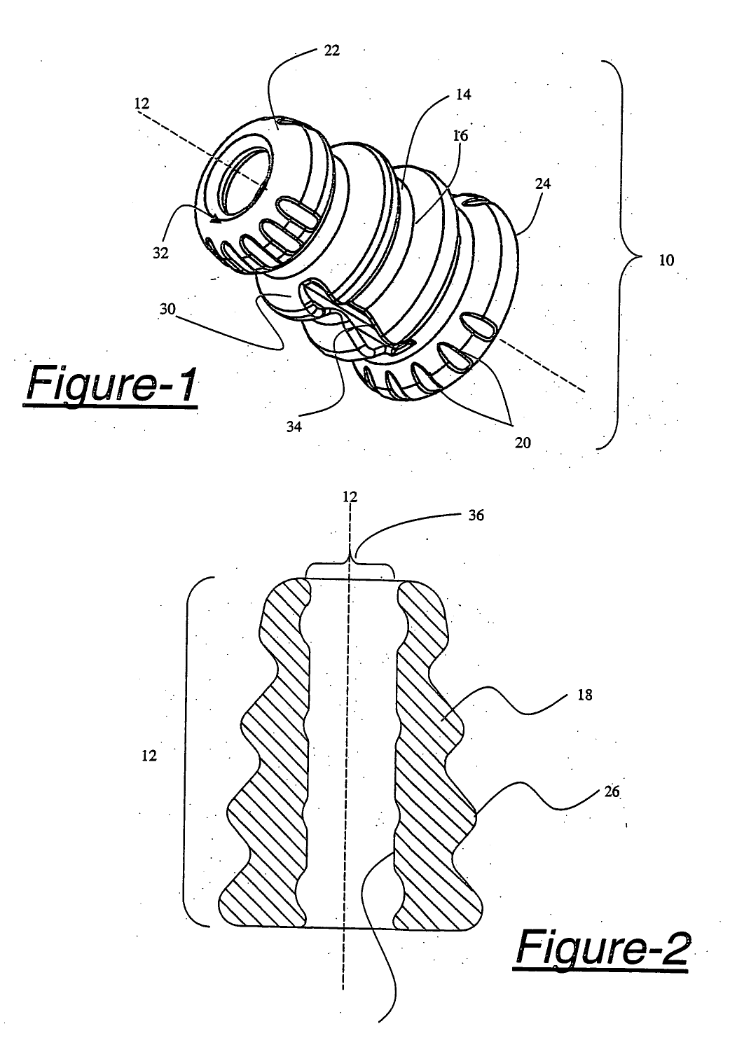

FIG. 1 generally illustrates a molded dog toy 10 made in accordance with an embodiment of the present invention. While being illustrated and described as a dog toy for a dog's use, it should be understood that the principles of this invention can be adapted for other animal toys.

As seen in FIGS. 1 and 2, the pet toy 10 illustrated in the figures has an elongated body 32 extending along axis 12 wherein the elongated body includes a first bulbous end 22 and a second bulbous end 24. These bulbous ends 22 and 24, as can be seen, can be connected by a series of ribs 14 and grooves 16. While the bulbous ends 22 and 24 are shown in the figures to be connected by ribs 14 and grooves 16, it should be understood that the bulbous ends 22 and 24 may be connected in other manners. For instance, the bulbous ends 22 and 24 could be connected by a smooth center section or a center section having different shapes and designs than those illustrated herein. As best seen in FIG. 2, the side wall 18 can define a cross section which varies along axis 12. A varying cross section facilitates an irregular bouncing path when the dog toy 10 has been dropped to the ground from a sufficient height. This creates an interest in the pet toy 10 by an animal such as a dog, cat or ferret.

Additionally, the side wall 18 can have, as shown in the figures, an outer surface 26 and an inner surface 28. The inner surface 28 of the side wall 18 can define an opening 36 which runs along the axis 12. This opening 36 can be advantageous because it allows the placement of objects inside the opening 36 which may make the pet toy 10 more attractive to pets. For example, pet treats, a rope or string could be placed into or through this opening 36. Although the inner diameter of the opening 36 is shown to be the same in the embodiment shown in the figures, it should be understood that one skilled in the art could construct a pet toy wherein the inner diameter of the first bulbous end 22 is different from the inner diameter of the second bulbous end 24 to modify the bouncing characteristics of the pet toy.

Furthermore, each bulbous end, as shown in the figures, may contain a plurality of indentations 20. These indentations 20 can be advantageous as they facilitate a pet gripping the pet toy in its mouth. While the indentations 20 are shown in the figures to be on the bulbous ends 22 and 24, it should be understood that the indentations 20 may be formed in other manners and constructions.

In the illustrated embodiments, the ribs 14 also contain distal surfaces 30 which assist in the cleaning of a pet's teeth. When a pet chews the elongated body 32, the pet's teeth can scrape along the distal surfaces 30 of the ribs 14. Plaque that has built up on the pet's teeth may be removed through repetitive chewing. Additionally, the distal surfaces 30 can massage the pet's gums when the pet chews the toy. Further, at least one notch 34, as shown in FIG. 1, can run along at least part of the outer surface 28 of the side wall 18 through the ridges 14 and the grooves 16. This notch 34 can also scrape a pet's teeth and massage a pet's gums in much the same way as the distal surfaces 30.

The pet toy shaped as described above can be molded from any suitable polymeric materials that could enable the toy to be buoyant in water while at the same time not easily destructible when a dog chews on it. Additionally, it is desirable that the material also be resilient in order to make the pet toy bounce when dropped to the ground from a sufficient height.

In order to meet the proceeding objectives, in at least one embodiment, polymeric materials suitable for use with the present invention should have an ultimate tensile strength between approximately 2 and 10 MPa, as measured by ASTM Test 3574, Test E, and a density between 0.25 and 0.95 g/cm³.

In another embodiment, polymeric materials suitable for use with the present invention may have a tensile strength between 3 and 7 MPa. In yet a further embodiment, polymeric materials suitable for use with the present invention may have a tensile strength between 4 and 6 MPa. In still yet another further embodiment, polymeric materials suitable for use with the present invention may have a tensile strength of 4 MPa. Tensile strengths in these ranges will help to ensure that the toy 10 will not easily rip or break.

In another embodiment, polymeric materials suitable for use with the present invention may have a density between 0.40 and 0.80 g/cm³. In yet a further embodiment, polymeric materials suitable for use with the present invention may have a density between 0.50 and 0.70 g/cm³. In still yet another further embodiment, polymeric materials suitable for use with the present invention may have a density of 0.60 g/cm³. Densities in these ranges will help ensure that the toy 10 is lighter than water, and thus will float in the water.

In another embodiment, polymeric materials suitable for use with the present invention may have an ultimate elongation between 200% and 600%, as measured by ASTM Test D412. In yet another embodiment, polymeric materials suitable for use with the present invention may have an elongation between 250% and 550%. In yet a further embodiment, polymeric materials suitable for use with this invention may have an ultimate elongation between 300% and 500%. In yet another further embodiment, the materials suitable for use with this invention may have an ultimate elongation between 350% and 450%. In still yet another further embodiment, the materials suitable for use with this invention may have an ultimate elongation of 400%. Ultimate elongations in these ranges will help to ensure toughness.

While the pet toy can be formed out of any suitable material having an ultimate tensile strength of 2-10 MPa and a density of 0.25-0.95 g/cm³, including thermoplastic and thermosetting elastomers and polyurethane, microcellular polyurethane is the preferred material.

In at least one embodiment, the material comprises microcellular polyurethane having a relatively closed cell structure wherein the cells have a cell size of 25-200 microns. In another embodiment, closed cells of the microcellular polyurethane may have a cell size of 50-150 microns. In a further embodiment, the closed cells of the microcellular polyurethane may have a cell size of 75-125 microns. In yet another further embodiment, the closed cells of the microcellular polyurethane may have a cell size of 100 microns. Cell sizes in these ranges will help to ensure bounce and uniformity.

In at least one embodiment, the microcellular polyurethane has a cell structure wherein 90% of the cells are closed cells. In a further embodiment, the microcellular polyurethane may have a cell structure wherein at least 95% of the cells are closed cells. In yet another embodiment, the microcellular polyurethane may have a cell structure wherein at least 99% of the cells are closed cells. In yet another further embodiment, the microcellular polyurethane may have a cell structure wherein 100% of the cells are closed cell. This closed cell structure is advantageous because it improves the buoyancy of the pet toy by preventing water from entering into the cells and thus “water logging” the pet toy.

An example of one suitable microcellular polyurethane which can be used is called Autothane® and is manufactured by Hyperlast of Derbyshire, United Kingdom. Autothane® is a thermoset formed via a foaming process using water as the foaming agent. Autothane® has an ultimate tensile strength of 4 MPa, an ultimate elongation of 400% and a density of 0.6-0.65 g/cm³. Additionally, Autothane® has a closed cell structure. Further, the cells in Autothane® have an average cell size of 100 microns.

Chain extenders, catalysts, blowing agents, functional additives, fillers and non-functional additives as well as other conventional polymeric material additives can be included as part of, or with, the polymeric material as is known in the art.

The molded pet toy 10 may be produced by any suitable manufacturing process generally known in the art. For example, the molded pet toy 10 may be produced by conventional injection molding.

Further, when the pet toy 10 is produced using Autothane®, the pet toy 10 can be manufactured by mixing a prepolymer with a resin and a foaming agent, such as water, at temperatures around 35-50° C. After mixing is complete the Autothane® can be liquid injected into closed molds. After molding, it take approximately 3-10 minutes for the Autothane® to set, at which point it may be removed from the molds. While at least one method of producing the pet toy 10 has been described herein, it should be understood that one skilled in the art could manufacture the pet toy 10 using any other manufacturing method capable of producing a material with the required specifications.

An additional aspect of this invention involves making the pet toy more attractive by flavoring or scenting the pet toy. Although applicant has found that dogs and other animals prefer toys made from polyurethane to toys made from other materials such as rubber due to polyurethane's neutral smell and taste, dogs further prefer toys that have been flavored or scented. To that end, the microcellular polyurethane can be flavored or scented during the molding process. Typical flavors and scents used would be those flavors and scents which would entice the type of pet playing with the pet toy. For example, a dog toy might be flavored with a chicken or beef flavor.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A lightweight, highly resilient floatable animal chew toy comprising:
a body made of elastomeric material having a density of less than 0.95 g/cm³ and a tensile strength of at least 2.0 MPa.

2. A lightweight, highly resilient, floatable animal chew toy comprising a body molded of elastomeric material having a density in the range of 0.25 to 0.95 g/cm³ and a tensile strength in the range of 2.0 to 10.0 MPa.

3. The animal chew toy of aspect 2 wherein the material has a minimum elongation in the range of 200%-600%.

4. The animal chew toy of aspect 2 wherein the material comprises a cellular material.

5. The animal chew toy of aspect 4 wherein the cellular material contains substantially closed cells.

6. The animal chew toy of aspect 4 wherein the material comprises a microcellular material.

7. The animal chew toy of aspect 6 wherein the microcellular material comprises pores and has a pore density of 20-48 pores/cm³.

8. The animal chew toy of aspect 6 wherein the microcellular material comprises pores having an average pore diameter of 25-200 microns.

9. The animal chew toy of aspect 8 wherein the material has a pore density of 15-46 pores/cm³.

10. The animal chew toy of aspect 6 wherein the material comprises microcellular polyurethane.

11. The animal chew toy of aspect 2 wherein the material has a flavor desirable to a dog.

12. The animal chew toy of aspect 6 wherein the microcellular material comprises pores and has a pore density of 15-46 pores/cm³.
